(19) United States
(12) Patent Application Publication
(10) Pub. No.: US 2024/0021797 A1
(43) Pub. Date: Jan. 18, 2024

(54) Composite Particle, Positive Electrode, All-Solid-State Battery, and Method of Producing Composite Particle

(71) Applicant: TOYOTA JIDOSHA KABUSHIKI KAISHA, Toyota-shi Aichi-ken (JP)

(72) Inventors: Masaru KUBOTA, Okazaki-shi Aichi-ken (JP); Hidenori MIKI, Hiratsuka-shi Kanagawa-ken (JP)

(73) Assignee: TOYOTA JIDOSHA KABUSHIKI KAISHa, Toyota-shi Aichi-ken (JP)

(21) Appl. No.: 18/220,378

(22) Filed: Jul. 11, 2023

(30) Foreign Application Priority Data
Jul. 14, 2022 (JP) 2022-113131

(51) Int. Cl. H01M 4/36; H01M 4/485; H01M 4/525; H01M 4/505; H01M 4/131; C01G 53/00; C01G 33/00

(52) U.S. Cl. CPC H01M 4/366; H01M 4/485; H01M 4/525; H01M 4/505; H01M 4/131; C01G 53/50; C01G 33/00; C01P 2002/70; C01P 2006/40

(57) ABSTRACT

A composite particle comprising: a positive electrode active material particle; and a coating film, wherein the coating film covers at least part of a surface of the positive electrode active material particle, and the coating film includes fluorine and at least one selected from the group consisting of phosphorus and a glass network forming element.

### CROSS REFERENCE TO RELATED APPLICATIONS

This application claims priority to Japanese Patent Application No. 2022-113131 filed on Jul. 14, 2022, with the Japan Patent Office, the entire contents of which are hereby incorporated by reference.

### BACKGROUND

### Technical Field

The present disclosure relates to a composite particle, a positive electrode, an all-solid-state battery, and a method of producing a composite particle.

### Description of the Background Art

Japanese Patent Laying-Open No. 2003-338321 discloses a high-voltage all-solid-state battery in which the surface of positive electrode active material is covered with an inorganic solid electrolyte that includes lithium (Li).

### SUMMARY

Forming a coating film on a surface of a positive electrode active material particle has been suggested. For example, in a sulfide-type all-solid-state battery, such a coating film is expected to inhibit a direct contact between a sulfide-based solid electrolyte and a positive electrode active material particle and thereby decrease initial resistance. However, there is room for improvement in post-endurance-test resistance increment under high voltage.

An object of the present disclosure is to decrease resistance increment.

Hereinafter, the technical configuration and effects of the present disclosure will be described. It should be noted that the action mechanism according to the present specification includes presumption. The action mechanism does not limit the technical scope of the present disclosure.

[1] A composite particle comprising:
a positive electrode active material particle; and
a coating film, wherein
the coating film covers at least part of a surface of the positive electrode active material particle, and
the coating film includes fluorine (F) and at least one selected from the group consisting of phosphorus (P) and a glass network forming element.
With the composite particle according to [1] above, a coating film with reduced resistance increment (in particular, a coating film with excellent endurance under high voltage) can be provided.

As a result of investigating materials for adding to the coating film, the inventors of the present disclosure have found that adding F to a coating film that includes at least one selected from the group consisting of P and a glass network forming element could decrease post-endurance-test resistance increment.

[2] The composite particle according to [1], wherein the glass network forming element is at least one selected from the group consisting of boron (B), silicon (Si), nitrogen (N), sulfur (S), germanium (Ge), and hydrogen (H).

[3] The composite particle according to [1] or [2], wherein a relationship of the following expression (1) is satisfied:

C_{F}/(C_{P}+C_{Z})≤0.2 (1)
where
each of C_{F}, C_{P}, and C_{Z} represents an element concentration measured by X-ray photoelectron spectrometry,
C_{F} represents an element concentration of fluorine,
C_{P} represents an element concentration of phosphorus, and
C_{Z} represents an element concentration of the glass network forming element.

[4] The composite particle according to any one of [1] to [3], wherein the coating film further includes a metallic element, and
the metallic element is at least one selected from the group consisting of aluminum (Al), titanium (Ti), and zirconium (Zr).

[5] A positive electrode comprising:
the composite particle according to any one of [1] to [4]; and
a sulfide-based solid electrolyte.

[6] An all-solid-state battery comprising the positive electrode according to [5].

[7] A method of producing a composite particle, the method comprising:
(a) preparing a mixture by mixing a coating liquid and a positive electrode active material particle; and
(b) producing a composite particle by drying the mixture, wherein
the coating liquid includes a solute and a solvent, and
the solute includes F and at least one selected from the group consisting of P and a glass network forming element.

The coating liquid that is adhered to the surface of the positive electrode active material particle may be dried to produce a coating film. The coating liquid according to [7] above allows for producing the coating film according to [1] above.

[8] The method of producing a composite particle according to [7], wherein
the coating liquid further includes a metallic element, and
the metallic element is at least one selected from the group consisting of Al, Ti, and Zr.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual view illustrating a composite particle according to the present embodiment.

FIG. 2 is a conceptual view illustrating an all-solid-state battery according to the present embodiment.

FIG. 3 is a schematic flowchart for a method of producing a composite particle according to the present embodiment.

### DETAILED DESCRIPTION

Next, an embodiment of the present disclosure (which may also be simply called “the present embodiment” hereinafter) and an example of the present disclosure (which may also be simply called “the present example” hereinafter) will be described.

It should be noted that neither the present embodiment nor the present example limits the technical scope of the present disclosure.

<Definitions of Terms, etc.>

Expressions such as “comprise”, “include”, and “have”, and other similar expressions (such as “be composed of”, for example) are open-ended expressions. In an open-ended expression, in addition to an essential component, an additional component may or may not be further included. The expression “consist of” is a closed-end expression. However, even when a closed-end expression is used, impurities present under ordinary circumstances as well as an additional element irrelevant to the technique according to the present disclosure are not excluded. The expression “consist essentially of” is a semiclosed-end expression. A semiclosed-end expression tolerates addition of an element that does not substantially affect the fundamental, novel features of the technique according to the present disclosure.

Expressions such as “may” and “can” are not intended to mean “must” (obligation) but rather mean “there is a possibility” (tolerance).

A singular form also includes its plural meaning, unless otherwise specified. For example, “a particle” may mean not only “one particle” but also “a group of particles (powder, particles)”.

As for a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Further, any numerical value selected from a certain numerical range may be used as a new upper limit or a new lower limit. For example, any numerical value from a certain numerical range may be combined with any numerical value described in another location of the present specification or in a table or a drawing to set a new numerical range.

When a compound is represented by a stoichiometric composition formula (such as “LiCoO₂”, for example), this stoichiometric composition formula is merely a typical example of the compound. The compound may have a non-stoichiometric composition. For example, when lithium cobalt oxide is represented as “LiCoO₂”, the composition ratio of lithium cobalt oxide is not limited to “Li/Co/O=1/1/2” but Li, Co, and O may be included in any composition ratio, unless otherwise specified. Further, doping with a trace element and/or substitution may also be tolerated.

“D50” refers to a particle size in volume-based particle size distribution at which cumulative frequency of particle sizes accumulated from the small size side reaches 50%. D50 may be measured by laser diffraction. For example, a laser-diffraction particle size distribution analyzer “SALD-7500” (trade name) manufactured by Shimadzu (or a similar product) may be used.

“A glass network forming element” refers to an element capable of forming glass. “Capable of forming glass” means that the element is capable of binding to oxygen (O) to form oxide glass that has a network structure.

<<XPS Measurement>>

(Particle Surface Composition Ratio)

C_{F}, C_{P}, and C_{Z} in the above expression (1) may be measured by the procedure described below. An XPS apparatus is prepared. For example, an XPS apparatus “PHI X-tool” (trade name) manufactured by ULVAC-PHI (or a similar product) may be used. A sample powder consisting of the composite particle is loaded in the XPS apparatus. With a pass energy of 224 eV, narrow scan analysis is carried out. The measurement data is processed with an analysis software. For example, an analysis software “MulTiPak” (trade name) manufactured by ULVAC-PHI (or a similar product) may be used. The peak area (integral value) of F 1s spectrum is converted to the element concentration of F (C_{F}). The peak area of P 2p spectrum is converted to the element concentration of P (C_{P}). For Z, a suitable spectrum is selected depending on the type thereof. For example, for B, the peak area of B is spectrum is converted to the element concentration of B (C_{P}). C_{F} is divided by the sum of C_{P} and C_{Z} to give the particle surface F composition ratio (C_{F}/(C_{P}+C_{Z})).

(Covering Rate)

The covering rate is also measured by XPS. The above-described measurement data is analyzed, and thereby, from the peak area for each of C 1s, O 1s, F 1s, P 2p, B 1s, M 2p3, and the like, the element ratio of the corresponding element is calculated.

For example, the covering rate is calculated by the following equation (2):

θ=(F+P+Z)/(F+P+Z+M)×100 (2)

In the above equation (2), θ represents the covering rate (%). Each of F, P, Z, and M represents the element ratio of the corresponding element.

It should be noted that M in “M 2p3” and in the above equation (2) refers to a constituent element of the positive electrode active material particle other than Li or oxygen (O). That is, the positive electrode active material particle may be represented by the following formula (3).

LiMO₂ (3)

M may consist of one type of element, or may consist of a plurality of elements. M may be, for example, at least one selected from the group consisting of nickel (Ni), cobalt (Co), manganese (Mn), and aluminum (Al). When M includes a plurality of elements, the sum of the composition ratios of the elements may be 1.

For example, when the positive electrode active material particle is “LiNi_{1/3}Co_{1/3}Mn_{1/3}O₂”, the above expression (2) may be changed into the following expression (3′).

θ=(F+P+Z)/(F+P+Z+Ni+Co+Mn)×100 (3′)

In the above expression (3′), Ni represents the element ratio of nickel calculated from the peak area for Ni 2p3, Co represents the element ratio of cobalt calculated from the peak area for Co 2p3, and Mn represents the element ratio of manganese calculated from the peak area for Mn 2p3.

<<Measurement of Film Thickness>>

The film thickness (the thickness of the coating film) may be measured by the procedure described below. The composite particle is embedded into a resin material to prepare a sample. With the use of an ion milling apparatus, a cross section of the sample is exposed. For example, an ion milling apparatus “Arblade (registered trademark) 5000” (trade name) manufactured by Hitachi High-Technologies (or a similar product) may be used. The cross section of the sample is examined by an SEM (Scanning Electron Microscope). For example, an SEM apparatus “SU8030” (trade name) manufactured by Hitachi High-Technologies (or a similar product) may be used. For each of ten composite particles, the film thickness is measured in twenty fields of view. The arithmetic mean of a total of 200 film thickness measurements is regarded as the film thickness.

<Composite Particle>

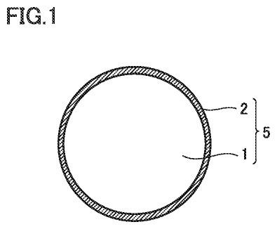

FIG. 1 is a conceptual view illustrating a composite particle according to the present embodiment. A composite particle 5 may also be called “a covered positive electrode active material”, for example. Composite particle 5 includes a positive electrode active material particle 1 and a coating film 2. Composite particle 5 may be an aggregate, for example. That is, a single composite particle 5 may include two or more positive electrode active material particles 1. Composite particle 5 may have a D50 from 1 to 50 μm, or may have a D50 from 1 to 20 μm, or may have a D50 from 5 to 15 μm, for example.

<<Coating Film>>

Coating film 2 is a shell for composite particle 5. Coating film 2 covers at least part of a surface of positive electrode active material particle 1.

Coating film 2 includes F and at least one selected from the group consisting of P and a glass network forming element. The glass network forming element may include, for example, at least one selected from the group consisting of B, Si, N, S, Ge, and H. When coating film 2 includes F and at least one selected from the group consisting of P and the glass network forming element, resistance increment is expected to be decreased.

The covering rate may be 80% or more, for example. When the covering rate is 80% or more, battery resistance is expected to be decreased. The covering rate may be 85% or more, or may be 90% or more, for example. The covering rate may be 100%, or may be 99% or less, or may be 95% or less, for example. The covering rate may be from 80 to 100%, for example.

Coating film 2 may have a thickness from 5 to 100 nm, or may have a thickness from 5 to 50 nm, or may have a thickness from 10 to 30 nm, or may have a thickness from 20 to 30 nm, for example.

The glass network forming element, together with O, may form oxide glass. That is, coating film 2 may include oxide glass that has a network structure. The oxide glass may include a phosphoric acid structure, a boric acid structure, and the like, for example. That is, coating film 2 may include, for example, at least one selected from the group consisting of a phosphoric acid structure and a boric acid structure. For example, when fragments of PO₂⁻, PO₃⁻, and/or the like is detected by TOF-SIMS (Time-of-Flight Secondary Ion Mass Spectrometry) of composite particle 5, it is regarded that coating film 2 includes a phosphoric acid structure. For example, when fragments of BO₂⁻, BO₃⁻, and/or the like is detected by TOF-SIMS of composite particle 5, it is regarded that coating film 2 includes a boric acid structure.

Composite particle 5 may satisfy the relationship of the following expression (1), for example:

C_{F}/(C_{P}+C_{Z})≤0.2 (1)

C_{F}, C_{P}, C_{Z} refer to element ratios measured by XPS. C_{F} refers to the element ratio of F. C_{P} refers to the element ratio of P. C_{Z} refers to the element ratio of the glass network forming element. When coating film 2 includes a plurality of types of glass network forming elements, C_{Z} represents the total element ratio of the glass network forming elements. When C_{F}/(C_{P}+C_{Z}) is 0.2 or less, resistance increment is expected to be decreased. For example, C_{F}/(C_{P}+C_{Z}) may be 0.15 or less, or may be 0.1 or less.

Composite particle 5 may also satisfy the relationship of the following expression (4), for example:

C_{F}/C_{P}≤0.2 (4)

When C_{F}/C_{P} is 0.2 or less, resistance increment is expected to be decreased. For example, C_{F}/C_{P} may be 0.15 or less, or may be 0.1 or less.

Coating film 2 may include Li, carbon (C), and/or the like, for example. Coating film 2 may further include at least one metallic element selected from the group consisting of Al, Ti, and Zr.

Composite particle 5 may satisfy the relationship of the following expression (5), for example:

C_{Y}/(C_{P}+C_{Z})≤0.1 (5)

C_{Y} refers to the element ratio of at least one metallic element selected from the group consisting of Al, Ti, and Zr measured by XPS. When coating film 2 includes a plurality of types of metallic elements, C_{Y} represents the total element ratio of the metallic elements. When C_{Y}/(C_{P}+C_{Z}) is 0.1 or less, resistance increment is expected to be further decreased. For example, C_{Y}/(C_{P}+C_{Z}) may be 0.05 or less, or may be 0.03 or less.

C_{Y} in the above expression (5) may be measured by the measurement method described above. For Y, a suitable spectrum is selected depending on the type thereof. For Al, for example, the peak area of Al2p spectrum is converted to the element concentration of Al (C_{Y}). C_{Y} is divided by the sum of C_{P} and C_{Z} to give the particle surface composition ratio of at least one metallic element selected from the group consisting of Al, Ti, and Zr (C_{Y}/(C_{P}+C_{Z})).

When coating film 2 further includes at least one metallic element selected from the group consisting of Al, Ti, and Zr, the covering rate is calculated by the following equation (6), for example. The covering rate may be measured by the measurement method described above.

θ=(F+P+Z+Y)/(F+P+Z+Y+M)×100 (6)

<<Positive Electrode Active Material Particle>>

Positive electrode active material particle 1 is the core of composite particle 5. Positive electrode active material particle 1 may be a secondary particle (a group of primary particles). Positive electrode active material particle 1 (secondary particle) may have a D50 from 1 to 50 μm, or may have a D50 from 1 to 20 μm, or may have a D50 from 3 to 15 μm, for example. The primary particles may have a maximum Feret diameter from 0.1 to 3 μm, for example.

Positive electrode active material particle 1 may include any component. Positive electrode active material particle 1 may include, for example, at least one selected from the group consisting of LiCoO₂, LiNiO₂, LiMnO₂, LiMn₂O₄, Li(NiCoMn)O₂, Li(NiCoAl)O₂, and LiFePO₄. “(NiCoMn)” in “Li(NiCoMn)O₂”, for example, means that the constituents within the parentheses are collectively regarded as a single unit in the entire composition ratio. As long as (NiCoMn) is collectively regarded as a single unit in the entire composition ratio, the amounts of individual constituents are not particularly limited. Li(NiCoMn)O₂ may include LiNi_{1/3}Co_{1/3}Mn_{1/3}O₂, LiNi_{0.5}Co_{0.2}Mn_{0.3}O₂, LiNi_{0.8}Co_{0.1}Mn_{0.1}O₂, and/or the like, for example.

<All-Solid-State Battery>

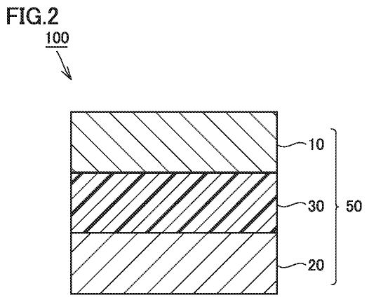

FIG. 2 is a conceptual view illustrating an all-solid-state battery according to the present embodiment. An all-solid-state battery 100 may include an exterior package (not illustrated), for example. The exterior package may be a pouch made of metal foil laminated film, and/or the like, for example. The exterior package may accommodate a power generation element 50. Power generation element 50 includes a positive electrode 10, a separator layer 30, and a negative electrode 20. That is, all-solid-state battery 100 includes positive electrode 10, separator layer 30, and negative electrode 20.

<<Positive Electrode>>

Positive electrode 10 is of layered form. For example, positive electrode 10 may include a positive electrode active material layer and a positive electrode current collector. For example, a positive electrode composite material may be applied to a surface of the positive electrode current collector to form the positive electrode active material layer. The positive electrode current collector may include an Al foil and/or the like, for example. The positive electrode current collector may have a thickness from 5 to 50 μm, for example.

The positive electrode active material layer may have a thickness from 10 to 200 μm, for example. The positive electrode active material layer is closely adhered to separator layer 30. The positive electrode active material layer includes a positive electrode composite material. The positive electrode composite material includes the composite particle and a sulfide-based solid electrolyte. That is, positive electrode 10 includes the composite particle and a sulfide-based solid electrolyte. The details of the composite particle are as described above.

The sulfide-based solid electrolyte may form an ion conduction path in the positive electrode active material layer. The amount of the sulfide-based solid electrolyte to be used may be, for example, from 1 to 200 parts by volume, or may be from 50 to 150 parts by volume, or may be from 50 to 100 parts by volume, relative to 100 parts by volume of the composite particle (a positive electrode active material).

The sulfide-based solid electrolyte includes S. The sulfide-based solid electrolyte may include Li, P, and S, for example. The sulfide-based solid electrolyte may further include O, Si, and/or the like, for example. The sulfide-based solid electrolyte may further include a halogen and/or the like, for example. The sulfide-based solid electrolyte may further include iodine (I), bromine (Br), and/or the like, for example. The sulfide-based solid electrolyte may be glass ceramic, or may be argyrodite, for example. The sulfide-based solid electrolyte may include, for example, at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, and Li₃PS₄.

For example, “LiI—LiBr—Li₃PS₄” refers to a sulfide-based solid electrolyte produced by mixing LiI, LiBr, and Li₃PS₄ in any molar ratio. For example, the sulfide-based solid electrolyte may be produced by a mechanochemical method. “Li₂S—P₂S₅” includes Li₃PS₄. Li₃PS₄ may be produced by, for example, mixing Li₂S and P₂S₅ in “Li₂S/P₂S₅=75/25 (molar ratio)”.

The positive electrode active material layer may further include a conductive material, for example. The conductive material may form an electron conduction path in the positive electrode active material layer. The amount of the conductive material to be used may be, for example, from 0.1 to 10 parts by mass relative to 100 parts by mass of the composite particle (the positive electrode active material). The conductive material may include any component. The conductive material may include, for example, at least one selected from the group consisting of carbon black, vapor grown carbon fiber (VGCF), carbon nanotube (CNT), and graphene flake.

The positive electrode active material layer may further include a binder, for example. The amount of the binder to be used may be, for example, from 0.1 to 10 parts by mass relative to 100 parts by mass of the composite particle (the positive electrode active material). The binder may include any component. The binder may include, for example, at least one selected from the group consisting of polyvinylidene difluoride (PVdF), vinylidene difluoride-hexafluoropropylene copolymer (PVDF-HFP), styrene-butadiene rubber (SBR), and polytetrafluoroethylene (PTFE).

<<Negative Electrode>>

Negative electrode 20 is of layered form. For example, negative electrode 20 may include a negative electrode active material layer and a negative electrode current collector. For example, a negative electrode composite material may be applied to a surface of the negative electrode current collector to form the negative electrode active material layer. The negative electrode current collector may include a copper (Cu) foil, a Ni foil, and/or the like, for example. The negative electrode current collector may have a thickness from 5 to 50 μm, for example.

The negative electrode active material layer may have a thickness from 10 to 200 μm, for example. The negative electrode active material layer is closely adhered to separator layer 30. The negative electrode active material layer includes a negative electrode composite material. The negative electrode composite material includes a negative electrode active material particle and a sulfide-based solid electrolyte. The negative electrode composite material may further include a conductive material and a binder. The negative electrode composite material and the positive electrode composite material may include the same type of, or different types of, sulfide-based solid electrolyte. The negative electrode active material particle may include any component. The negative electrode active material particle may include, for example, at least one selected from the group consisting of graphite, Si, silicon oxide [SiOₓ (0<x<2)], and Li₄Ti₅O₁₂.

<<Separator Layer>>

Separator layer 30 is interposed between positive electrode 10 and negative electrode 20. Separator layer 30 separates positive electrode 10 from negative electrode 20. Separator layer 30 includes a sulfide-based solid electrolyte. Separator layer 30 may further include a binder. Separator layer 30 and the positive electrode composite material may include the same type of, or different types of, sulfide-based solid electrolyte. Separator layer 30 and the negative electrode composite material may include the same type of, or different types of, sulfide-based solid electrolyte.

### Method of Producing Composite Particle

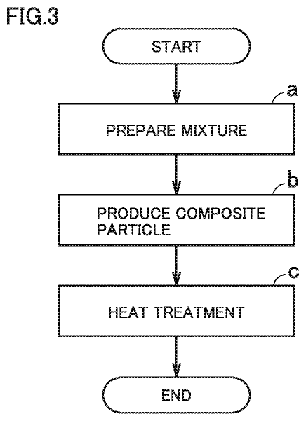

FIG. 3 is a schematic flowchart for a method of producing a composite particle according to the present embodiment. Hereinafter, “the method of producing a composite particle according to the present embodiment” may also be simply called “the present production method”. The present production method includes “(a) preparing a mixture” and “(b) producing a composite particle”. The present production method may further include “(c) heat treatment” and the like, for example.

<<(a) Preparing Mixture>>

The present production method includes preparing a mixture by mixing a coating liquid and a positive electrode active material particle. The details of the positive electrode active material particle are as described above. For example, the mixture may be a suspension, or may be a wet powder. For example, the suspension may be formed by dispersing the positive electrode active material particle (powder) in the coating liquid. For example, the wet powder may be formed by spraying the coating liquid into the powder. In the present production method, any mixing apparatus and/or any granulating apparatus may be used, for example.

The coating liquid includes a solute and a solvent. The solute includes F and at least one selected from the group consisting of P and a glass network forming element, as a raw material of the coating film. The coating liquid may further include suspended matter (an insoluble component), sediment, and/or the like, for example.

The amount of the solute may be, for example, from 0.1 to 20 parts by mass, or may be from 1 to 15 parts by mass, or may be from 5 to 10 parts by mass, relative to 100 parts by mass of the solvent. As long as it can dissolve the solute, the solvent may include any component. The solvent may include water, alcohol, and/or the like, for example. The solvent may include ion-exchanged water and/or the like, for example.

The details of the glass network forming element are as described above.

The solute may include, for example, at least one selected from the group consisting of an oxoacid of the glass network forming element and an oxide of the glass network forming element. The solute may include, for example, at least one selected from the group consisting of phosphoric acid, boric acid, silicic acid, nitric acid, sulfuric acid, and germanic acid. The solute may include orthophosphoric acid, metaphosphoric acid, orthoboric acid, metaboric acid, and/or the like, for example.

In the coating liquid described above, the relationship of the following expression (7) may be satisfied, for example.

n_{F}/(n_{P}+n_{Z})≤0.2 (7)

In the above expression (7), n_{F} represents the molarity of F, n_{P} represents the molarity of P, and n_{Z} represents the molarity of the glass network forming element. When the coating liquid includes a plurality of types of glass network forming elements, n_{Z} represents the total molarity of the glass network forming elements. When the molar ratio is 0.2 or less, resistance increment is expected to be decreased. For example, n_{F}/(n_{P}+n_{Z}) may be 0.15 or less, or may be 0.1 or less.

In the coating liquid described above, the relationship of the following expression (8) may also be satisfied, for example.

n_{F}/n_{P}≤0.2 (8)
When the molar ratio is 0.2 or less, resistance increment is expected to be decreased. For example, n_{F}/n_{P} may be 0.15 or less, or may be 0.1 or less.

The solute may further include at least one metallic element selected from the group consisting of Al, Ti, and Zr. In the coating liquid, the relationship of the following expression (9) may be satisfied, for example.

n_{Y}/(n_{P}+n_{Z})≤0.1 (9)
n_{Y} represents the molarity of at least one metallic element selected from the group consisting of Al, Ti, and Zr. When the coating liquid includes a plurality of types of metallic elements, n_{Y} represents the total molarity of the metallic elements. When the molar ratio is 0.1 or less, resistance increment is expected to be further decreased. For example, n_{Y}/(n_{P}+n_{Z}) may be 0.05 or less, or may be 0.03 or less.

The solute may further include a lithium compound. The solute may include lithium hydroxide, lithium carbonate, lithium nitrate, and/or the like, for example.

<<(b) Producing Composite Particle>>

The present production method includes producing a composite particle by drying the mixture described above. The coating liquid that is adhered to the surface of the positive electrode active material particle is dried to produce a coating film. In the present production method, any drying method may be employed.

For example, spray drying may be employed to form the composite particle. More specifically, a suspension is sprayed from a nozzle to form droplets. The droplets include the positive electrode active material particle and the coating liquid. For example, the droplets may be dried by the use of hot air to form the composite particle. The use of spray drying is expected to enhance the covering rate, for example.

The solid content (volume fraction) of the suspension for use in the spray drying may be from 1 to 50%, or may be from 10 to 30%, for example. The diameter of the nozzle may be from 0.1 to 10 mm, or may be from 0.1 to 1 mm, for example. The temperature of the hot air may be from 100 to 200° C., for example.

For example, a tumbling fluidized-bed coating apparatus may be used to produce the composite particle. Such a tumbling fluidized-bed coating apparatus is capable of performing “(a) preparing a mixture” and “(b) producing a composite particle” at the same time.

<<(c) Heat Treatment>>

The present production method may include subjecting the composite particle to heat treatment. The heat treatment allows the coating film to be fixed. The heat treatment may also be called “calcination”. In the present production method, any heat treatment apparatus may be used. The heat treatment temperature may be from 150 to 300° C., for example. The duration of the heat treatment may be from 1 to 10 hours, for example. The heat treatment may be carried out in the air, or the heat treatment may be carried out in an inert (nitrogen) atmosphere, for example.

### EXAMPLES

In the following, the present embodiment will be described using Examples, but the present embodiment is not limited to these Examples.

<<No. 1>>

(Positive Electrode)

870.4 parts by mass of a hydrogen peroxide solution (mass concentration, 30%) was placed in a vessel. Then, to the vessel, 987.4 parts by mass of ion-exchanged water and 44.2 parts by mass of niobic acid [Nb₂O₅·3H₂O] were added. Then, to the vessel, 87.9 parts by mass of an aqueous ammonia solution (mass concentration, 28%) was added. The content of the vessel was sufficiently stirred to form a coating liquid. The resulting coating liquid is expected to include a peroxo complex of Nb.

As a positive electrode active material particle, Li(Ni_{1/3}Co_{1/3}Mn_{1/3})O₂ was prepared. 50 parts by mass of the positive electrode active material particle in powder form was dispersed in 53.7 parts by mass of the coating liquid to prepare a suspension. A spray dryer “Mini Spray Dryer B-290” (trade name) manufactured by BUCHI was prepared. The suspension was fed into the spray dryer, and thereby powder of composite particle was produced. The temperature of air supplied by the spray dryer was 200° C., and the amount of air supply was 0.45 m³/min. The composite particle was subjected to heat treatment in the air. The temperature of the heat treatment was 200° C. The duration of the heat treatment was 5 hours. The coating film of the composite particle according to No. 1 is expected to include LiNbO₃. The covering rate was measured by the above-described procedure. Results are shown in Table 1 below. In the same manner, the covering rate was measured for Nos. 2 to 6 described below.

The below materials were prepared.
Sulfide-based solid electrolyte: 10LiI-15LiBr-75Li₃PS₄
Conductive material: VGCF
Binder: SBR
Dispersion medium: heptane
Positive electrode current collector: Al foil

The composite particle, the sulfide-based solid electrolyte, the conductive material, the binder, and the dispersion medium were mixed together to prepare a positive electrode slurry. The mixing ratio between the composite particle and the sulfide-based solid electrolyte was “(composite particle)/(sulfide-based solid electrolyte)=6/4 (volume ratio)”. The amount of the conductive material to be used was 3 parts by mass relative to 100 parts by mass of the composite particle. The amount of the binder to be used was 3 parts by mass relative to 100 parts by mass of the composite particle. The positive electrode slurry was sufficiently stirred with the use of an ultrasonic homogenizer (trade name “UH-50”, manufactured by SMT). The positive electrode slurry was applied to a surface of the positive electrode current collector to form a coat film. The resulting coat film was dried on a hot plate at 100° C. for 30 minutes. In this way, a positive electrode raw sheet was produced. From the resulting positive electrode raw sheet, a disk-shaped positive electrode was cut out. The area of the positive electrode was 1 cm².

(Negative Electrode)

The below materials were prepared.
Negative electrode active material particle: graphite
Sulfide-based solid electrolyte: 10LiI-15LiBr-75Li₃PS₄
Conductive material: VGCF
Binder: SBR
Dispersion medium: heptane
Negative electrode current collector: Cu foil

With the use of a stirring apparatus (FILMIX (registered trademark) “model 30-L”, manufactured by PRIMIX), the sulfide-based solid electrolyte, the conductive material, the binder, and the dispersion medium were mixed together to prepare a slurry. The stirring rate (the number of revolutions) was 2000 rpm, and the stirring duration was 30 minutes. After 30 minutes of stirring, the negative electrode active material particle was added to the slurry, and the slurry was further stirred. The stirring rate was 15000 rpm, and the stirring duration was 60 minutes.

The mixing ratio between the negative electrode active material particle and the sulfide-based solid electrolyte was “(negative electrode active material particle)/(sulfide-based solid electrolyte)=6/4 (volume ratio)”. The amount of the conductive material to be used was 1 part by mass relative to 100 parts by mass of the negative electrode active material particle. The amount of the binder to be used was 2 parts by mass relative to 100 parts by mass of the negative electrode active material particle.

The slurry was applied to the surface of the negative electrode current collector to form a coat film. The resulting coat film was dried on a hot plate at 100° C. for 30 minutes. In this way, a negative electrode raw sheet was produced. From the resulting negative electrode raw sheet, a disk-shaped negative electrode was cut out.

The area of the negative electrode was 1 cm².

(Separator Layer)

The below materials were prepared.

Sulfide-based solid electrolyte: LiI—Li₂S—P₂S₅(glass ceramic type, D50=2.5 m)

As a die for press work, a ceramic cylinder having an inner cross-sectional area of 1 cm² was prepared. Into the die, 64.8 mg of the sulfide-based solid electrolyte was placed, made even, and then pressed and compacted at a pressure of 1 ton/cm² to give a separator layer.

(All-Solid-State Battery)

Inside the die, the positive electrode was placed on one side of the separator layer and the negative electrode was placed on the other side. At a pressure of 6 ton/cm² for 1 minute, the negative electrode, the separator layer, and the positive electrode were pressed together. A stainless steel rod was inserted into the positive electrode and the negative electrode to provide restraint at 0.5 ton/cm² to form a power generation element. As a case, a pouch made of an aluminum-laminated film was prepared. The power generation element was sealed into the case. In this way, an all-solid-state battery was formed.

<<No. 2>>

To 166 parts by mass of ion-exchanged water, 10.8 parts by mass of metaphosphoric acid (manufactured by FUJIFILM Wako Pure Chemical) was dissolved to form a phosphoric acid solution. Into the resulting phosphoric acid solution, boric acid (manufactured by Nacalai Tesque) was further dissolved so that the molar ratio of B to P became 1.0, and thereby a coating liquid was prepared. Except for these, the same operation as in No. 1 was carried out to produce a composite particle, a positive electrode, and an all-solid-state battery. In the composite particle according to No. 2, the coating film is expected to include BₓPO_{y} (each of x and y is any number) such as BPOₓ, for example; the same is true for Nos. 3 to 6 described below.

<<No. 3>>

A composite particle, a positive electrode, and an all-solid-state battery were produced in the same manner as in No. 1 except that the same coating liquid as in No. 2 was prepared and the heat treatment for the composite particle was carried out in a nitrogen atmosphere at 400° C.

<<No. 4>>

Into the coating liquid according to No. 2, ammonium fluoride (manufactured by FUJIFILM Wako Pure Chemical) was further dissolved so that the molar ratio of F to P and glass network forming element B became 0.1, and thereby a coating liquid was prepared. From this point onward, the same operation as in No. 1 was carried out to produce a composite particle, a positive electrode, and an all-solid-state battery. By the above-described procedure, the particle surface composition ratio (C_{F}/(C_{P}+C_{Z})) (Z═B) was measured. Results are shown in Table 1 below. In the same manner, the particle surface composition ratio (C_{F}/(C_{P}+C_{Z})) was measured for Nos. 5 to 6 described below.

<<No. 5>>

A composite particle, a positive electrode, and an all-solid-state battery were produced in the same manner as in No. 1 except that the same coating liquid as in No. 4 was prepared and the heat treatment for the composite particle was carried out in a nitrogen atmosphere at 400° C.

<<No. 6>>

Into the coating liquid according to No. 4, aluminum nitrate nonahydrate (manufactured by FUJIFILM Wako Pure Chemical) was further dissolved so that the molar ratio of metallic element Al to P and B became 0.05, and thereby a coating liquid was prepared. From this point onward, the same operation as in No. 1 was carried out to produce a composite particle, a positive electrode, and an all-solid-state battery. By the above-described procedure, the particle surface composition ratio (C_{Y}/(C_{P}+C_{Z})) (Y═Al, Z═B) was measured. Results are shown in Table 1 below.

<Evaluation>

The initial capacity of the all-solid-state battery (hereinafter also called “the cell”) was checked. The conditions for charging and discharging are as follows.
Charging: Constant current-constant voltage mode, Rate=1/3 C
Discharging: Constant-current mode, Rate=1/3 C

After the initial capacity was checked, SOC of the cell was adjusted to 40%. At a rate of 2 C, the cell was discharged for 5 seconds. From the amount of voltage drop after a lapse of 5 seconds, initial resistance was determined. Results are shown in Table 1 below.

After the measurement of initial resistance, the cell was stored in a thermostatic chamber at 60° C. for 14 days. During the storage, trickle charging was performed to the cell so that the positive electrode electric potential was maintained at 4.5 V. After a lapse of 14 days, post-endurance resistance was measured under the same conditions as for initial resistance measurement. The post-endurance resistance was divided by the initial resistance to determine resistance increment. Results are shown in Table 1 below.

TABLE 1

| | | | | Composite particle | | | | | |
|---|---|---|---|---|---|---|---|---|---|
| | | | | XPS particle | XPS particle | | All-solid-state battery | | |
| | | | | surface | surface | XPS | | Post- | |
| | Coating film | | | composition | composition | covering | Initial | endurance | Resistance |
| | | | Metallic | ratio | ratio | rate | resistance | resistance | increment |
| No. | Composition | F | element | (C_{F}/(C_{P} + C_{Z})) | (C_{Y}/(C_{P} + C_{Z})) | (%) | (Ω) | (Ω) | (—)*¹ |
| 1 | LiNbO₃ | None | None | — | — | 95 | 10 | 21 | 2.10 |
| 2 | BPO_{X} | None | None | — | — | 95 | 10 | 21 | 2.10 |
| 3 | BPO_{X} | None | None | — | — | 94 | 31 | 99 | 3.19 |
| 4 | BPO_{X} | Included | None | 0.12 | — | 86 | 12 | 21 | 1.75 |
| 5 | BPO_{X} | Included | None | 0.12 | — | 85 | 16 | 29 | 1.81 |
| 6 | BPO_{X} | Included | Included | 0.07 | 0.02 | 93 | 10 | 18 | 1.80 |
| | | | (Al) | | | | | | |

*¹The value is the ratio of post-endurance resistance to initial resistance.

### Results

In Nos. 4 to 6 where the coating film includes F and at least one selected from the group consisting of P and a glass network forming element, the resistance increment decreases.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A composite particle comprising:
a positive electrode active material particle; and
a coating film, wherein
the coating film covers at least part of a surface of the positive electrode active material particle, and
the coating film includes fluorine and at least one selected from the group consisting of phosphorus and a glass network forming element.

2. The composite particle according to claim 1, wherein the glass network forming element is at least one selected from the group consisting of boron, silicon, nitrogen, sulfur, germanium, and hydrogen.

3. The composite particle according to claim 1, wherein a relationship of the following expression (1) is satisfied:
C_{F}/(C_{P}+C_{Z})≤0.2 (1)
where
each of C_{F}, C_{P}, and C_{Z} represents an element concentration measured by X-ray photoelectron spectrometry,
C_{F} represents an element concentration of fluorine,
C_{P} represents an element concentration of phosphorus, and
C_{Z} represents an element concentration of the glass network forming element.

4. The composite particle according to claim 1, wherein
the coating film further includes a metallic element, and
the metallic element is at least one selected from the group consisting of aluminum, titanium, and zirconium.

5. A positive electrode comprising:
the composite particle according to claim 1; and
a sulfide-based solid electrolyte.

6. An all-solid-state battery comprising the positive electrode according to claim 5.

7. A method of producing a composite particle, the method comprising:
(a) preparing a mixture by mixing a coating liquid and a positive electrode active material particle; and
(b) producing a composite particle by drying the mixture, wherein
the coating liquid includes a solute and a solvent, and
the solute includes fluorine and at least one selected from the group consisting of phosphorus and a glass network forming element.

8. The method of producing a composite particle according to claim 7, wherein
the coating liquid further includes a metallic element, and
the metallic element is at least one selected from the group consisting of aluminum, titanium, and zirconium.
